(19) United States
(12) Patent Application Publication
(10) Pub. No.: US 2024/0418650 A1
(43) Pub. Date: Dec. 19, 2024

(54) METHOD AND MICROSCOPE FOR DETERMINING FLOW PROPERTIES IN A SAMPLE CHAMBER THROUGH WHICH A MEDIUM FLOWS

(71) Applicant: Carl Zeiss Microscopy GmbH, Jena (DE)

(72) Inventors: Annette Bergter, Jena (DE); Volker Doering, Jena (DE)

(73) Assignee: Carl Zeiss Microscopy GmbH, Jena (DE)

(21) Appl. No.: 18/746,129

(22) Filed: Jun. 18, 2024

(30) Foreign Application Priority Data
Jun. 19, 2023 (DE) 10 2023 205 715.8

(51) Int. Cl. G01N 21/64; G01N 11/00

(52) U.S. Cl. CPC G01N 21/6428; G01N 11/00; G01N 2011/008; G01N 2021/6439

(57) ABSTRACT

A method and a microscope determine flow properties in a sample chamber through which a medium flows. The method includes detecting detection radiation from a confocal volume generated in the sample chamber with a plurality of detector elements of a detector in the form of a detector array at a plurality of points in time. The detector is arranged in a plane conjugate to the rear-side image plane of an objective. The measurement values from the detector elements can be analyzed individually. Cross correlations of the acquired measurement values from the detector elements of at least one pair are generated in two directions and analyzed. The confocal volume is generated at at least two mutually different locations of the sample chamber. At each location, a speed and optionally a movement direction of the medium are determined to create a flow profile over at least one region of the sample chamber.

### CROSS-REFERENCE TO RELATED APPLICATIONS

This patent application is based on and claims priority pursuant to 35 U.S.C. § 119(a) to German Patent Application No. DE 10 2023 205 715.8, filed on Jun. 19, 2023, in the German Patent Office, the entire disclosure of which is hereby incorporated by reference in its entirety.

### BACKGROUND

### Field of the Invention

The invention relates to a method for determining flow properties in a sample chamber through which a medium flows. The invention additionally relates to a microscope suitably configured for carrying out the method.

### Description of Related Art

In the field of microscopy, in particular confocal laser scanning microscopy, there is an interest in identifying movements of objects in a sample chamber and determining their properties, such as speed and direction. Of particular interest here is the provision of data on flow profiles, for example in order to assess effects of the design of sample chambers such as for example tubes, reaction chambers or miniaturized reaction chambers (cavities) in cell culture chambers (“lab-on-a-chip”; “organ-on-a-chip”).

DE 10 2023 201 620 (unpublished) discloses a method for investigating movements of molecules. The method of fluorescence correlation spectroscopy (FCS) is used here, for example, to investigate the dynamics of the behavior of molecules in cells. The method, also referred to as FCS for short, is available in various variants (e.g.: Lenne et al., 2006, EMBO J. 25: 3245-3256 and Wenger et al., 2007, Biophys. J. 92: 913-919). One of the variants is what is known as “spot variation FCS” (e.g.: Wawreznieck et al., 2005, Biophys. J. 89: 4029-4042). Here, excitation radiation is focused and directed into a sample chamber. As a result of the focusing and the extent of the focus of the focused beam of the excitation radiation both transversely (x- or y-direction) to the propagation direction (usually optical axis) and along the propagation direction (z-direction), what is known as a confocal volume (also referred to in this context as “focus” for simplification) is illuminated in the sample chamber in conjunction with confocal detection. Pieces of brightness information (measurement values) can be acquired for confocal volumes of different sizes. The brightness information is acquired by means of an optical detector (e.g., photodiode).

From the publication by Scipioni et al. (2018; Nature Communications, DOI: 10.1038/s41467-018-07513-2) a variation of the spot variation FCS is known. For detection purposes, use is made of a spatially resolving surface detector, the detector elements of which can be read and evaluated individually and independently of one another. Specifically, a detector type referred to as an “Airyscan detector” is used in Scipioni et al.; it is arranged in an intermediate image plane of a detection beam path and the respective detector elements thereof act as individual pinholes (Huff, 2015, Nature Methods, Application Notes, December 2015).

DE 10 2023 201 620 describes the targeted reading of the measurement values from selected pairs of such a two-dimensional detector. Cross correlations can be used to determine the speed and direction of moving molecules that emit detection radiation in the form of fluorescence radiation, within biological cells.

### SUMMARY OF THE INVENTION

The object of the invention is to propose a possibility for determining flow properties in a sample chamber through which a medium flows, in particular in sample chambers with small dimensions.

The object is achieved by the subject-matter of the description herein. Further embodiments relate to advantageous developments.

### DETAILED DESCRIPTION OF THE INVENTION

The method according to the invention for determining flow properties in a sample chamber through which a medium flows comprises the following steps. In a step A, detection radiation that originates in a confocal volume generated in the sample chamber is detected. The detection is carried out with a plurality of detector elements of a detector array at a plurality of points in time over a measurement period (also: measurement period, measurement interval; for example, 10 seconds to a few minutes per measurement duration in each case), wherein the detector array is arranged in a plane conjugate to the rear-side image plane of an objective. This conjugate plane is also referred to as the “pinhole plane”. The measurement values from the detector elements can each be read and analyzed on an individual basis. It is also possible to combine the measurement values from respective selected detector elements with one another (“binning”).

Moreover, at least one pair of detector elements is selected, wherein each of the two partners in a pair is formed by at least one detector element. A pair is formed by at least one selected detector element and a further selected detector element.

In a further method step (step B), cross correlations of the acquired measurement values are created from the measurement values for at least one pair among themselves. In the process, in a first substep B1 cross correlations are calculated starting from one of the selected detector elements in a first direction to the further selected detector element. This first direction can also be referred to as forward direction.

In a second substep B2, cross correlations are additionally calculated starting from the further selected detector element in a second direction (back direction) to the first selected detector element.

In a step C, the cross correlations or their results are analyzed in respect of the occurrence of a change in the intensity of the measurement values from selected detector elements.

The method according to the invention is characterized in that the confocal volume is generated at at least two mutually different locations of the sample chamber. In order to address different locations, the confocal volumes may optionally overlap here by at most 50% of their extent in the z-direction or in their cross section in the x-direction and/or in the y-direction to the z-direction.

In the present description, according to a Cartesian coordinate system, a direction of the main flow of the medium in the sample chamber is referred to as the direction x and a direction orthogonal thereto is referred to as direction y. The z-axis (direction z) is perpendicular to both directions, and the detection radiation is usually detected along it.

The locations where measurements are taken can be selected manually, for example using an appropriate user interface, or automatically. For example, a user can specify a rule according to which the number and positions of the locations are determined. It is possible here to select locations that lie absolutely in the sample chamber or locations relative respectively to samples that are located in the sample chamber, for example. The locations can also be selected using a previously acquired overview image of the sample chamber and/or a sample. Samples as referred to herein are artificial or biological structures which are located in the sample chamber and toward which the medium flows and/or that are surrounded by the medium. Artificial structures consist mainly of technical materials such as metal, alloys and plastics, but optionally also of biogenic materials and can be, for example, vascular implants. Biological structures include cells, cell layers, spheroids, organoids and tissues of organisms or whole organisms, for example.

At each of the locations, a speed and optionally a movement direction of the medium are determined on the basis of the cross correlations by virtue of a plurality of cross correlations, in particular, being calculated over pairs with different alignments and all the curves thus obtained being fitted with the directions and/or a speed as parameter.

The speeds and, where appropriate, the movement directions per location are assigned to each other and stored retrievably in order to create a speed profile, or, if the respective movement direction is added, a flow profile, over at least one spatial region of the sample chamber.

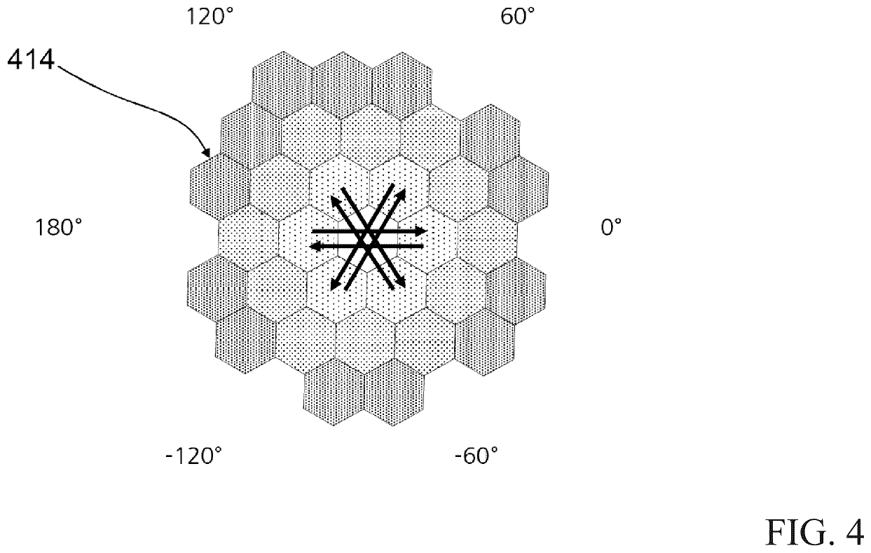

Within this description, the term direction is used, in conjunction with a calculation of cross correlations, within the sense of a vector having a starting point and a virtual propagation line. This means that in a horizontal, for example, a first direction (forward direction) runs toward 0° from a starting point and a second direction (back direction) runs toward 180° from a starting point (see also FIG. 4). A corresponding statement applies to (polar) coordinate systems with a different alignment.

The core of the invention is to use measurement values from selected and in particular individually readable detector elements to obtain information of flows, for example by means of movements of specific objects, in a flowing medium and to produce as a result a flow profile over at least one region of the sample chamber. For each measurement point (location), a speed currently reached there and optionally a movement direction of the objects are determined here. To simplify matters, the following text will refer to a flow profile, even if only a speed profile can be created. A flow profile is generated from measurement values for a plurality of different measurement points. The measurement values combined into a flow profile are advantageously determined within a defined measurement period in order to ensure their interaction or their simultaneous presence. Within the scope of this description, objects refer to molecules, for example proteins, nucleic acids and the derivatives thereof, aggregations, complexes, conglomerates and chelates in particular.

The objects used to determine the flow properties are preferably labeled with fluorophores or are themselves capable of emitting fluorescence radiation (fluorophores). The emitted fluorescence radiation detected as detection radiation is caused in particular by means of excitation radiation radiated into the sample chamber.

In order to conserve a sample in the sample chamber and/or objects in the medium, the excitation radiation is shaped and directed only into selected regions of the sample chamber in each case.

Localized excitation is advantageously synchronized with a detection of detection radiation at the respective location.

Advantageously, an already existing configuration of an optical arrangement suitable for generating confocal volumes, for example of a microscope, can be used for the embodiment of the invention in order to ascertain data without additional equipment outlay. Use is made here of the circumstance that each of the detector elements images a slightly different portion of the confocal volume. Thus, a plurality of mutually different detection foci are generated and their measurement values are analyzed, wherein the very high precision of the manufacture and arrangement of the detector elements and also of the optical elements upstream thereof, for example microlens arrays, in what are known as Airyscan detectors (Huff, 2015, Nature Methods; Application Notes, December 2015) and arrays of SPAD (single photon avalanche diode) detectors advantageously requires a very precise knowledge of the distances of the respective confocal volumes. Compared with the solutions from the prior art, the exact knowledge with regards to the position and nature of the respective confocal volumes advantageously allows a calibration thereof, for example using known dye molecules as references, to be dispensed with.

The basic procedure according to the invention is explained by way of example below on the basis of an Airyscan detector with 32 channels (Huff, 2015, Nature Methods; Application Notes, December 2015). Further detectors suitable for the implementation of the invention are, for example, SPAD arrays and other surface detectors with individually readable or combined (“binned”) detector elements.

As may be gathered by way of example from FIG. 4, the use of the Airyscan detector allows six cross correlations to be calculated if a respective detector element spacing remains between the detector elements that form a pair and if the outer detector elements are unused (see below). In this case, a difference between the cross correlations calculated for opposite directions indicates a movement of an object that causes or emits detection radiation.

To determine a speed and a direction of the moving object, it is possible to create an experimental cross correlation of the form specified with regards to Equation [1] or by means of more detailed models.

The equation in relation to [1] is:

$$G ( τ ) = A exp ( - \frac{{r}_{0}^{2} + {τ}^{2} {v}^{2} - 2 {r}_{0} τ v cos α}{4 D τ + {w}_{0}^{2}} ) {G}_{diff} ( τ ) \qquad [ 1 ]$$

where v is the flow speed (fit parameter); α is an angle between the flow direction and a vector connecting the detector elements (fit parameter); r₀ is the distance between the foci of the detector elements of an (extended) pair; w₀ is the 1/e² radius of the confocal volume in XY for a detector element; D is the diffusion coefficient and G_{diff}(T) is the diffusion term (2-D or 3-D). The latter describes the autocorrelation in the absence of a movement for a detector element.

The parameter r₀ cannot be calculated directly from the spacing between the detector elements; instead, it must be determined empirically or theoretically. The reason for this can be found in the circumstance that the PSF (point spread function) of the illumination radiation and the PSF of the detection radiation are not the same. On the one hand, the parameter r₀ can be determined by virtue of a static sample, for example a color solution, being measured, wherein r₀ is inserted as parameter to be fitted and the flow speed is set to v=0. Alternatively, r₀ can be derived from a theoretical PSF, for example by using cross correlations with the theoretical PSF and adjusting (“fitting”) them by means of equation [1].

Fitting a plurality of cross correlations for different directions improves the stability of the fits with regards to the angle α. In contrast to prior-art methods with two foci, all cross correlations can also be determined from a single set of measurement values.

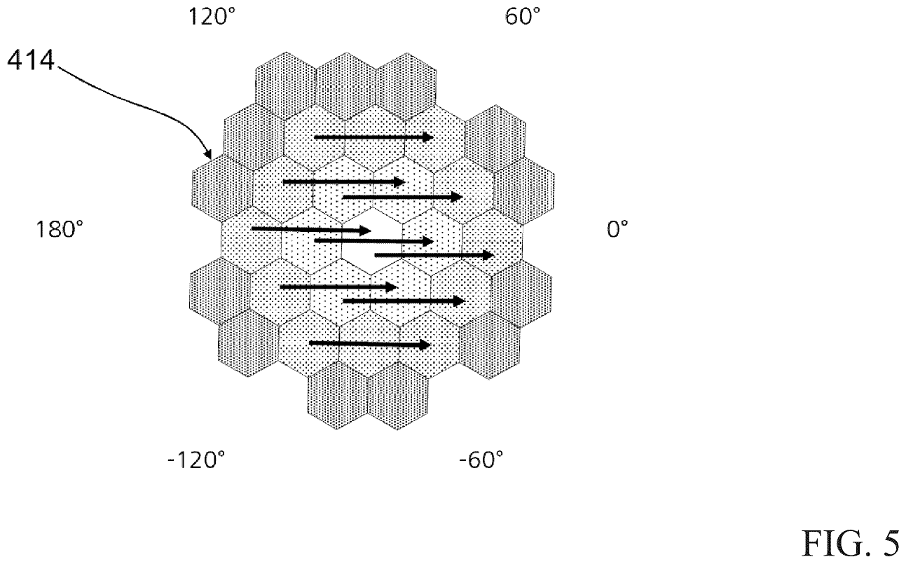

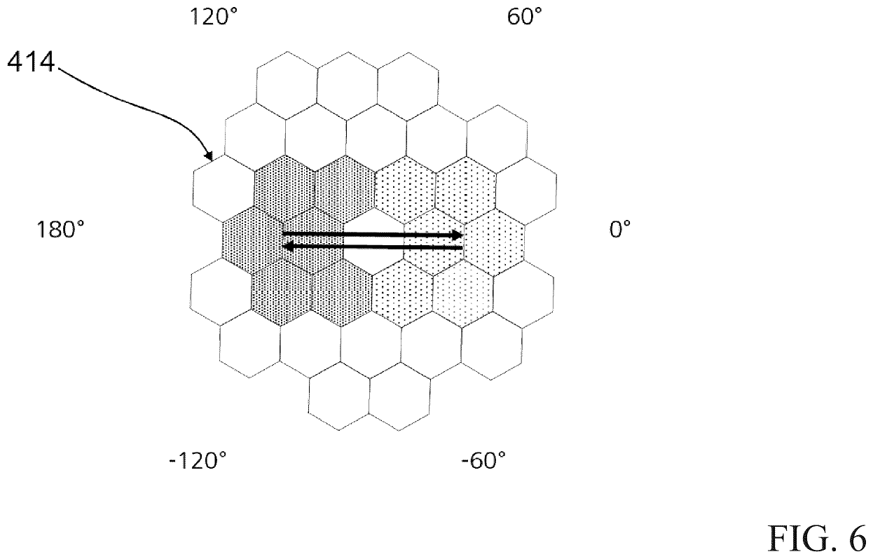

In a further method configuration, it is possible for a plurality of detector elements to be combined to form a respective one of the parts or partners of a pair in each case; this is referred to below as extended pair. In this case, the acquired measurement values per partner of the extended pair are mathematically combined, for example averaged, before a cross correlation is determined between the measurement values, thus mathematically combined, of the two partners of the extended pair. The method according to the invention can be implemented using only one pair or one extended pair of detector elements. To improve the signal-to-noise ratio, a group of a plurality of pairs and/or extended pairs of detector elements can be defined in a further configuration. In this case, the imaginary connecting lines of the center points of each pair or extended pair run substantially parallel to one another. Although the imaginary connecting lines may, merely by way of example, start at center points of different detector elements, they all run toward 0° for example (see also FIG. 5). After the measurement values acquired per pair were averaged, Equation [1] can again be applied to the measurement values from the pairs selected thus. Similar applies to the second direction, i.e. the back direction, for example toward 180°. In these cases, the forward direction can also be referred to as the common first direction and the back direction can also be referred to as the common second direction.

For more in-depth analyses and/or calculations in particular, an average value of the cross correlations in the first direction and/or second direction, created from the measurement values from the pairs or extended pairs, can be formed in each case and optionally saved for further use. An advantage of the method according to the invention lies in the circumstance that a plurality of pairs or extended pairs can be analyzed at the same time. Groups of pairs or extended pairs are advantageously analyzed in this case, wherein the respective common directions of the imaginary connecting lines between the (extended) pairs of each of the groups are aligned differently from one another.

Based on the results of the cross correlations, a current concentration of objects excited for the emission of fluorescence radiation can also be advantageously determined.

In an advantageous configuration of the method according to the invention, a plurality of cross correlations can be calculated, for example, over pairs/extended pairs with different alignments, for example at least two different groups, or their average values (see above). Optionally, all curves obtained thus can be fitted with the corresponding directions and/or speed as parameters (global fit).

When selecting the detector elements of the respective pairs/extended pairs, it is possible to map a sufficient diffusion path or flow path by virtue of the selected pairs being spatially separated in each case by at least one detector element not belonging to the pair in question. Accordingly, the detector elements belonging to an extended pair may be selected to be distant from one another by at least the distance corresponding to the width of a detector element.

As will be explained below, the detector elements that have a sufficiently similar radius of the confocal volume and whose distances from one another are the same can be selected in particular.

However, the results obtained using measurement values from peripheral detector elements for local speeds and movement directions have also proven to be valid and robust.

To increase the efficiency of the method according to the invention, it is possible to shape a point spread function (PSF) of illumination radiation which is used for generating the confocal volume and is directed along an illumination beam path into the sample chamber and/or of the detected detection radiation such that, in particular, the detector elements which are provided or suitable as partners of the pairs or extended pairs for a subsequent analysis acquire measurement values.

For example, the cross section of the illumination beam path can be stretched in a direction transversely to the respective beam path such that it has an elongate-oval cross section. Such beam shaping can be attained by means of a suitable slit stop or by the effect of an appropriately controlled spatial light modulator (SLM).

Optionally, further properties of moving objects can be derived on the basis of the data ascertained by means of the method according to the invention, in particular on the basis of the results of the cross correlations. Thus, it is advantageously possible to determine a local temperature (micro-temperature) of a medium, for example of a matrix or solvent of the sample, at the origin of the detection radiation.

Further, it is possible to determine a viscosity of the medium at the origin of the detection radiation, more precisely of the respective component of the detection radiation. For example, the basis is the equation also referred to as Einstein-Stokes equation [2]:

$$D ( T ) = {k}_{B} T / ( 6 π η ( T ) r ) . \qquad [ 2 ]$$

where:
D is the diffusion coefficient,
kB is Boltzmann's constant,
T is the absolute temperature,
η is the dynamic viscosity of the medium and
r is the hydrodynamic radius (Stokes radius) of an object.

The multiple temperature dependencies of elements of the relationship are evident from Equation [2]. The viscosity η or its change can be determined, for example, in the case of a constant temperature T and arising changes in the pressure.

The invention can advantageously be used in flowed-through sample chambers such as tubes, cavities of what are known as cell culture chambers, biochips, reaction chambers, flow chambers and the like. The sample chambers here are preferably components of microfluidic arrangements or systems.

For example, in one possible use, the influence of the wall of the respective sample chamber in the region of the measurements on at least one speed profile can be investigated by setting properties of the wall in a relationship with (associated) determined flow properties. In addition to the dimensioning, the material of the wall and/or a macrostructuring and/or microstructuring of its surface can also be properties of the wall.

The high spatial resolution of the measurements which can be advantageously achieved by means of the invention allows flow properties to be determined in very small sample chambers and correspondingly small-scale flow profiles to be created. The spatial resolution of the method according to the invention is determined by the diffraction-limited extent of the illumination volume. The resolution achievable by means of the method according to the invention is less than 100 nm, in particular about 40 nm, in the directions x and y. In the direction z, a resolution of approximately 10 nm can be achieved.

Measurement values in the direction z, i.e. in the detection direction, can be measured currently with sufficient quality up to a depth of a few millimeters, for example less than 3 mm, for example about 1 mm, in particular up to about 500 μm, depending on the optical properties of the wall of the sample chamber, of the medium and of the fluorescent objects. For example, confocal volumes can be generated with a PSF qualitatively suitable for the evaluation up to depths (direction z) of 150 to 200 μm (at a working distance of, for example, 400 μm). The manifestation here of the PSF, depending on the optical properties of the components involved and on the wavelength of the excitation radiation and the emitted detection radiation, is of particular importance for the attainable quality of the obtained data. Larger depths are achievable with further improvements and adjustment of the optical elements.

In a further possible application of the invention, both the flow behavior of an object located in the medium, for example a moving or (free)-floating cell, and also its influence on the flow behavior in the sample chamber can be investigated. If, for example, the cell or a tissue is able to generate a flow itself, for example by means of its cilia, the generated flow and/or its interaction with any further flow present in the sample chamber can also be investigated.

Flow properties, in particular flow profiles, can also be determined depending on the presence and/or specific dimensioning of objects serving as samples, such as spheroids, tissues, organoids and/or other three-dimensional structures.

A further application of the invention is the measurement of flow properties in vivo within a blood vessel or the blood vessel system of an organism. For example, this is possible with zebrafish, as long as the zebrafish is still optically transmissive for the excitation radiation and the detection radiation during its development.

Due to the high achievable spatial resolution, effects of the modification of a wall of the sample chamber can be investigated in applications of the method according to the invention, for example.

Thus, it is possible to determine the flow properties of a medium in a replica of a blood vessel in an untreated state and to compare them with the flow properties in a treated state, for example after insertion of a vascular implant (stent).

A further area of application of the method according to the invention is basic biomedical research. For example, the distribution of pharmacologically active substances in a sample chamber and their supply to a biological sample can thus be investigated and described. The method can also be used in materials research, in particular biomedical materials research, and also in quality control. It is also advantageous that flow properties of the medium and the transport behavior of the pharmacological active substance can be determined by means of the method according to the invention on the one hand, and furthermore the absorption and the location of the active substance can be detected and investigated within biological structures using the same microscope, for example using the methodology described in DE 10 2023 201 620. To do so, the sample chamber can be advantageously simply left on the sample stage of the microscope.

The method according to the invention can be used in addition or as an alternative for providing measurement values as input data for models and/or for verifying existing simulations. In addition to mathematical simulations and models, such input data can also for example be used for methods of machine learning and artificial intelligence (collectively referred to as simulations and models). Both approaches can be implemented for both general and individual situations in the sample chamber.

For example, simulations and models can be developed, improved and applied with or without a sample in the sample chamber.

A fundamental advantage of the invention is that interventions in the sample or in the sample chamber to be observed can be kept very low. No additional hardware is required, but existing systems can be used. Only their control and evaluation is adapted to the method according to the invention.

The invention is typically carried out with wavelengths of the excitation radiation in a range of about 440 to 640 nm. In further configurations, excitation wavelengths up to 1600 nm, for example, are possible when using a multiphoton excitation.

In order to carry out the method according to the invention, a microscope can be used for determining flow properties in a sample chamber through which a medium flows. For example, microscopes that are suitable for performing fluorescence-based methods, such as fluorescence correlation spectroscopy (FCS) or FRAP (fluorescence recovery after photobleaching) microscopy, can be used. Such microscopes can be, for example, point-scanning or line-scanning microscopes.

In further embodiments of the invention, illumination with excitation radiation can be carried out, for example in the form of a thin light sheet. In this way, only objects within the region illuminated layer-by-layer in the light sheet are excited to emit fluorescence radiation (e.g.: Singh, A. P. et al., The performance of 2D array detectors for light sheet based fluorescence correlation spectroscopy, Optics Express, 21(7) (2013) 8652-8668).

In an advantageous embodiment, the microscope has in the sample chamber an objective for detecting detection radiation coming from a confocal volume generated in the sample chamber and a detection beam path along which the detected detection radiation is steered to a detector array having a plurality of detector elements, wherein the detector array is arranged in a plane conjugate to the rear-side image plane of the objective (image plane; pinhole plane) and the measurement values from the detector elements can be read individually. The plane is in particular an intermediate image plane in which at least one pinhole is arranged in a confocal detection beam path. In a microscope according to the invention, the function of the pinhole is fulfilled by the individual detector elements of the detector.

As a detector, one of the already mentioned Airyscan detectors or SPAD arrays can advantageously be present. Optical elements such as microlens arrays, for example, may be placed in front of the detector elements. Other two-dimensional detectors with individually readable detector elements are also possible.

A microscope according to the invention may have a zoom optical unit. The latter can serve for the controlled modification of an extent of the beam of the detection radiation, for example to adapt the extent of a beam of the detected detection radiation to the size of a detection surface (detection plane) of a spatially resolving detector.

The microscope according to the invention also comprises an analysis unit configured for carrying out the method described herein. Such an analysis unit may be, for example, a computer, a microcontroller or an FPGA.

Furthermore available is a control unit which can be designed not only for controlling components of the microscope, but also for selecting locations and/or the approach of selected locations. Selected locations are approached by placing the sample chamber and/or objective in a relative position to each other at which a focus of the detection beam path of the microscope is directed to the selected location.

The analysis unit and control unit can be individual components of the microscope. In a further embodiment, they are correspondingly configured compartments of a computational device, such as a computer or a control circuit.

The method according to the invention can be advantageously supported by adapting the beam shape of the illumination radiation or the detection radiation according to the current requirements. To this end, a controllably settable iris diaphragm can be arranged as a beam-shaping optical unit in the illumination beam path or in the detection beam path of the microscope, for example. For example, a reduction in the diameter of the illumination beam path brings about underfilling on the input side of the objective pupil and hence leads to an increase in the confocal volume.

In an embodiment of the microscope according to the invention, a controllably settable (laser) beam expander can be arranged as a beam-shaping optical unit in the illumination beam path or in the detection beam path of the microscope. Beam expanders are typically based on telescopic constructions. The confocal volume can likewise be increased or decreased by the effect of the settings of a motorized variable beam expander.

In a further embodiment of the microscope according to the invention, a slit stop can be arranged as a beam-shaping optical unit in the illumination beam path or in the detection beam path, the effect of which creating a PSF that is elongate transversely to the beam path. The presence of an optical element modulating the PSF in space and/or time is likewise possible, for example a spatial light modulator (SLM) or correspondingly controllably settable phase masks and/or phase masks that can be controllably brought into and out of the beam path.

The aforementioned stops or optical elements can be advantageously controlled and the optical effect thereof can be influenced in a targeted manner.

The invention is explained below on the basis of exemplary embodiments and figures, in which:

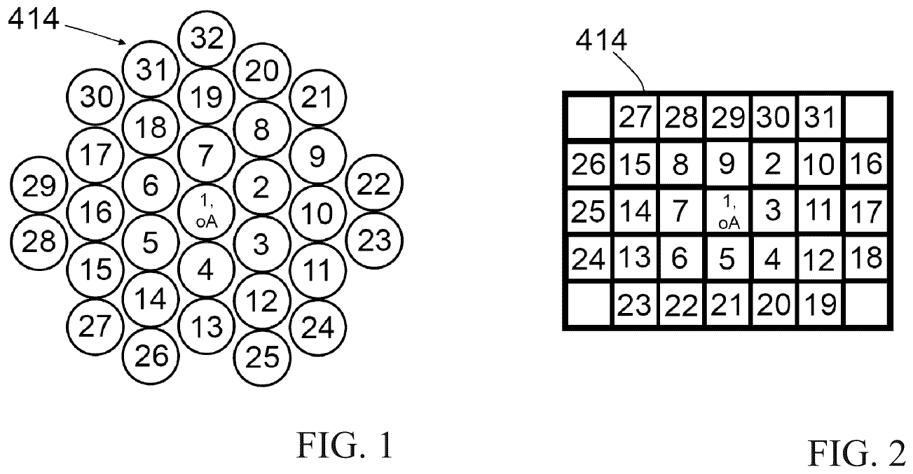

FIG. 1 shows a schematic illustration of a first example of a detector array;

FIG. 2 shows a schematic illustration of a second example of a detector array;

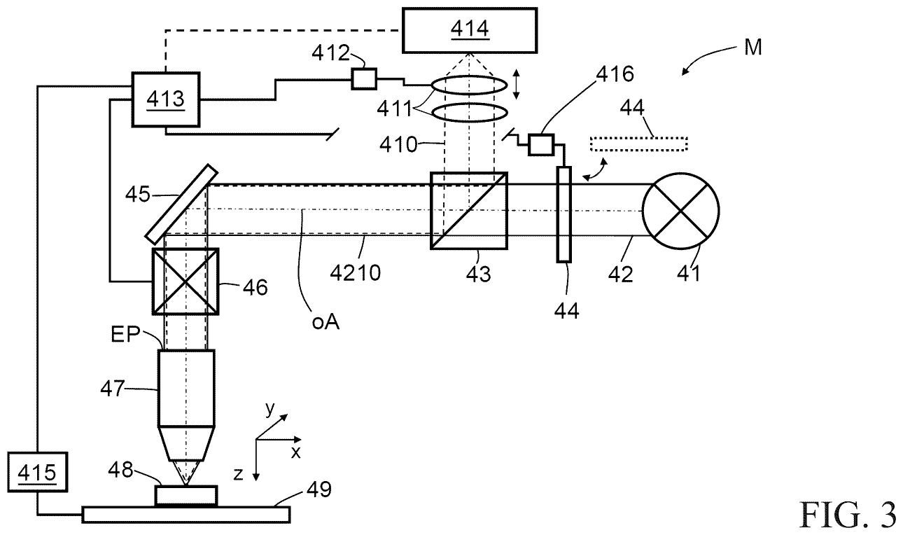

FIG. 3 shows a schematic illustration of an exemplary embodiment of a microscope according to the invention;

FIG. 4 shows a schematic illustration of a detector array and pairs of detector elements selected by way of example;

FIG. 5 shows a schematic illustration of the detector array and a group of selected pairs of detector elements;

FIG. 6 shows a schematic illustration of a detector array and an extended pair of detector elements selected by way of example;

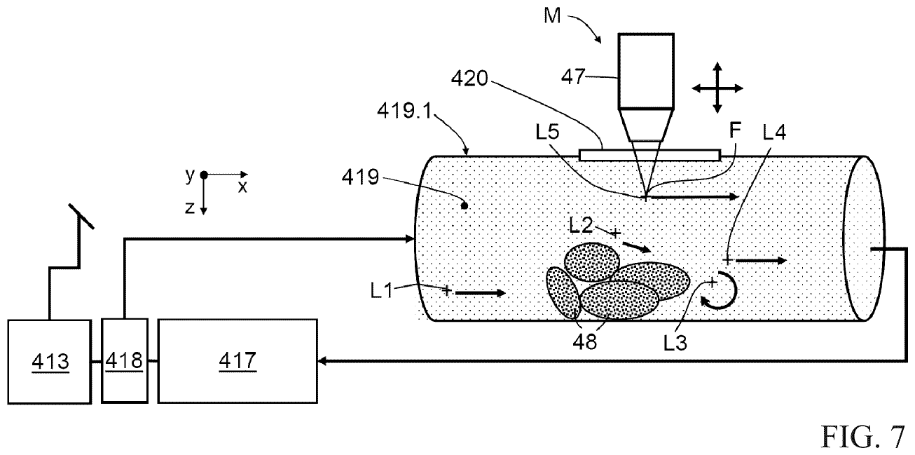

FIG. 7 shows a schematic illustration of a sample chamber through which a medium flows, of a microscope according to the invention, and of components of a device for conveying media; and

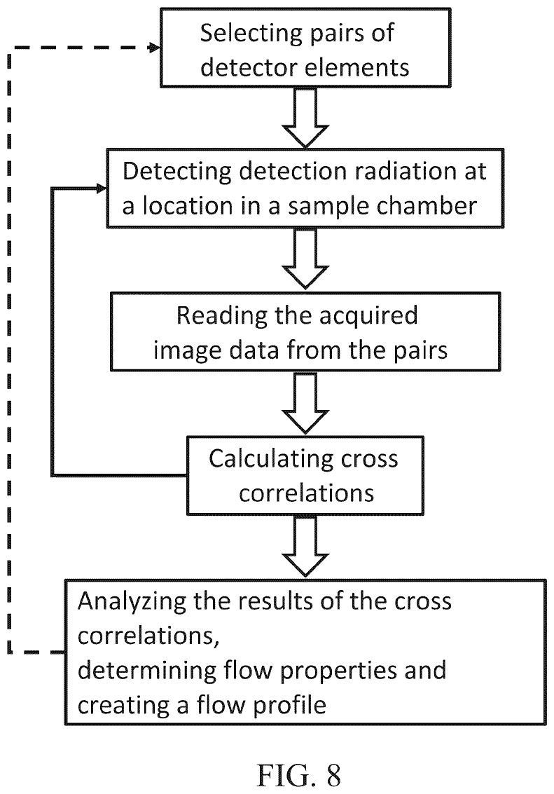

FIG. 8 shows a diagram of a configuration of the method according to the invention.

In the exemplary embodiments and figures, identical technical elements are provided with the same reference signs. The figures are not to scale.

A detector 414 in the form of what is known as an Airyscan detector can be seen in FIG. 1, in a plan view of its detection plane or detection surface. The detector 414 of this embodiment comprises 32 detector elements 1 to 32 and can be used as a spatially resolving detector 414. The acquired brightness information (measurement values) of the detector elements 1 to 32 are readable individually and can also be combined with one another as desired (“binning”). The extent of the beam of detection radiation (see also FIG. 3) can for example be selected such that it is incident on the detection plane with 1.25 Airy units (AU). For example, each of the detector elements 1 to 32 can cover a portion of 0.2 AU. The central detector element denoted by reference sign “1” is located on the optical axis (oA) of the detection beam path 410 (see FIG. 3).

FIG. 2 shows a further embodiment of a spatially resolving detector 414 in a row and column arrangement of the detector elements 1 to 31, as can be realized, for example, in a SPAD array, a CMOS chip or an sCMOS chip. Here, too, the pieces of brightness information from the detector elements 1 to 31 are readable individually or can be combined as desired.

FIG. 3 schematically shows a microscope M according to the invention. The latter comprises a light source 41, for example a laser light source, starting from which a beam of excitation radiation (illumination radiation) is emitted and guided along an illumination beam path 42 (excitation beam path 42). Optional optical elements for shaping and/or collimation of the excitation radiation are not shown. Arranged in the illumination beam path 42 is optionally a beam-shaping optical unit 44 for the controlled modification of an extent of the beam, which in the exemplary embodiment is in the form of a controllably settable stop. In further embodiments, a turret or a slide can also be present, by means of which different stops can be introduced into the illumination beam path 42. Alternatively, the beam-shaping optical unit 44 can also be a controllably settable telescope, a beam expander, a zoom optical unit, an acousto-optic element or an SLM.

The beam-shaping optical unit 44 can be moved out of the illumination beam path 42 by means of a drive 416 (indicated by a dashed line) to effect different numerical apertures, within whose respective angular ranges the excitation radiation can be directed into a sample 48 to be imaged. The beam-shaping optical unit 44 may be settable in further embodiments with regard to its transmissivity for the excitation radiation, in particular with regard to a hole diameter (pinhole, iris diaphragm) or the length and width of a slit or transparent region (settable slit aperture, acousto-optic element) or the angle alignment and the phase information.

After passing through the beam-shaping optical unit 44, the excitation radiation is incident on a main color splitter 43, which is transmissive for the excitation radiation and allows it to pass. Downstream of the main color splitter 43, the excitation radiation passes through a portion of the beam path of the microscope M which is referred to as the common beam path 4210 and along which the excitation radiation and detection radiation (see below) are guided together or can be guided together.

By means of a scanner 46 arranged thereafter, the beam of the excitation radiation which was previously diverted by means of a mirror 45 can be controllably deflected and be directed into the entrance pupil EP of an objective 47. The mirror 45 allows a compact design and may be omitted in further embodiments of the device if no diversion of the illumination beam path 42 is required or envisaged.

The excitation radiation, which is set by the effect of the beam-shaping optical unit 44 in its lateral extent and controllably deflected by means of the scanner 46, is focused by the effect of the objective 47 into a sample chamber in which the sample 48 to be imaged may be present on a sample stage 49. In combination with the confocal detection, the excitation radiation radiated in with such focusing brings about a confocal excitation volume.

Detection radiation brought about in the sample 48 by way of the excitation radiation in the confocal excitation volume is captured by the objective 47 and guided along a detection beam path 410 (shown with dashed full lines), which coincides with the excitation beam path 42 up to the main color splitter 43.

In further embodiments of the device according to the invention, the detection radiation can be captured by means of a further objective (not shown). In such a case, the excitation beam path 42 and the detection beam path 410 can be completely separated from one another or they are combined again, for example by means of a further color splitter (not shown), to form the common beam path 4210.

In the illustrated exemplary embodiment, the detection radiation is converted into a resting beam as a consequence of passing through the scanner 46 (“descanned”) and reaches the main color splitter 43. The latter is reflective to the wavelength of the detection radiation, which differs from the wavelength of the excitation radiation. The detection radiation reflected at the main color splitter 43 reaches a zoom optical unit 411 optionally present in the detection beam path 410. The zoom optical unit is controllably settable by means of a zoom drive 412. In further embodiments, the transmissivity and the reflectivity of the main color splitter 43 may also be implemented in reverse, with the result that the excitation radiation is reflected and the detection radiation is allowed to pass through. The beam paths 42 and 410 must then be designed accordingly.

The beam-shaping optical unit 44, the scanner 46, the zoom drive 412, and the drives 415 and 416 and optionally the light source 41 are suitably connected to an analysis and control unit 413 for exchanging data and control commands. For example, the analysis and control unit 413 is a computer or a suitable control circuit and is configured to carry out the method according to the invention. In particular, it is configured to carry out and assess cross correlations of image data from the above-described pairs, extended pairs and/or groups, and optionally configured to determine diffusion coefficients, flow speeds and flow directions of moving objects, local temperatures and/or local viscosities.

The zoom optical unit 411 is a means for controlled modification of an extent of the beam of the detection radiation, by means of which the extent of a beam of the detected detection radiation can be adapted to the size of a detection surface (detection plane) of a spatially resolving detector 414 also arranged in the detection beam path 410 in an intermediate image (“pinhole plane”). The aim here is to illuminate the detection surface in full where possible or adapt the latter accordingly to the respective requirements. Accordingly, the detection radiation is directed at the detector 414 by means of the zoom optical unit 411 and adapted with regard to the extent of its beam by means of the zoom drive 412.

Optionally, the control unit 413 and the detector 414 can be interconnected, for example to allow the control unit 413 to generate control commands and/or validate these, on the basis of the acquired brightness information from the detector 414. By way of example, these control commands serve to control the light source 41, the means 44, the scanner 46, the zoom drive 412, and/or an optional drive 415 of the sample stage 49.

FIGS. 4 to 6 in each case specify technical circumstances on the basis of the detector elements 1 to 32 of a detector 414 of the Airyscan detector type. Similar applies to detectors 414 of the type presented in FIG. 2. In a subsequent specification of the numbers of the relevant detector elements, reference is made to FIG. 1. The central detector element 1 is shown in the following FIGS. 4 to 6 without a pattern fill for better clarity.

FIG. 4 once again shows a plan view of the detection surface of the detector 414 (rotated approximately 30° anticlockwise vis-à-vis FIG. 1). For the purposes of the description, directions are defined proceeding from detector element 1 and, by way of example, denoted by degree values between 0° and 180° and −60° and −120°. Arrows are used to show three pairs of selected detector elements by way of example, wherein the start and end of each arrow indicates one partner of the relevant pair. The direction of the arrow indicates the forward direction and the back direction of the six cross correlations performed overall based on the intensity values (brightness values, measurement values) recorded by the partners of each pair. The different pattern fillings highlight the three rings arranged around the central detector element 1.

If only the pairs and directions shown by way of example in relation to FIG. 4 are supplied to the determination of cross correlations, then the efficiency of the method is low since acquired measurement values from other detector elements remain unconsidered. However, if use is made of the circumstance that the radius of the confocal volume w₀ for the central detector element 1 and the inner two rings of the detector elements 2 to 19 is approximately constant, then it is possible to select and define nine pairs of detector elements for each direction, as illustrated by way of example in FIG. 5 for the direction 180°->0°. The nine curves obtained therefrom can be averaged and fitted using Equation [1]. The use of the plurality of curves improves the signal-to-noise ratio.

Cross correlations for the other five directions (−120°->60°, −60°->120°, 0°->180°, 60°->−120° and 120°->−60°; not shown) can be calculated in the same way.

In a further method configuration, the measurement values from the detector elements 20 to 32, or 19 to 31 according to FIG. 2, can also be used, for example depending on a selected imaging ratio of the zoom optical unit 411 (see FIG. 3) and the resultant signal strengths of the individual channels (detector elements). For example, the measurement values from the detector elements 1 to 19 or 1 to 18 can thus be used for the actual FCS calculation, and the measurement values from the detector elements 20 to 32, or 19 to 31 can thus be used for the determination of flow properties and consequently for the creation of a flow profile.

In an alternative configuration of the method according to the invention, a plurality of detector elements are combined to form extended pairs. In FIG. 6, this is shown by way of example for detector elements 5, 6, 7, 16, 17 and 18 as elements of the one partner of the extended pair and detector elements 2, 3, 4, 10, 11 and 12 as elements of the other partner of the extended pair. In this example, cross correlations can be calculated for the directions 180°->0° (common first direction, forward direction) and 0°->180° (common second direction, back direction), wherein the measurement values from the elements of each partner of the extended pair were previously averaged. The center points of the respective partners of the extended pair are spaced apart from one another by more than the extent of one of the detector elements 1 to 32.

In FIG. 7, a sample chamber 419 in the form of a tubular cavity, for example a bioreactor or a cell culture chamber, is shown schematically. The sample chamber 419 is laterally bounded by a wall 419.1. In further embodiments, this wall can be planar or curved in sections. The wall 419.1 can be made of different materials and optionally have surface structures on its side surface facing the sample chamber 419.

In the wall 419.1, a window 420 transparent for excitation radiation and/or detection radiation may optionally be present. This is then advantageous if the wall 419.1 is not transparent or the manifestation of the detection PSF during passage through the wall 419.1 is very adversely affected.

A window 420 allows an inverse or lateral arrangement of the beam paths for excitation and detection, so that, for example, the installation space above the sample chamber 419 is still available for other technical elements.

Alternatively, the sample chamber 419 is open to the top, and the excitation and detection are carried out through the corresponding opening in the sample chamber 419.

A medium flowing through the sample chamber 419 (illustrated as a dot pattern) may be freshly provided and/or stored in a container 417. By means of a pump 418, medium from the container 417 can be guided into and back out of the sample chamber 419 via lines (shown in simplified form). The pump 418 is controllable by means of the control unit 413. Optionally, the medium is returned to the container 417 to be used again. In other embodiments, the medium can also be disposed of or used in other ways after leaving the sample chamber 419.

The container 417 can be connected with other components, which act to process used medium for reuse. For example, nutrients, hormones, growth factors, pharmacological agents and/or gases such as oxygen can be added thereto.

The sample chamber 419 contains, for example, a cell cluster as a sample 48, which is shown here with dark dots.

Within the sample chamber 419, selected locations L1 to L5 are marked with a + by way of example.

The current respective flow direction at the respective location L1 to L5 and a respective flow speed are illustrated by means of arrows. In order to determine a turbulent flow that is stable at least over a measurement period, as is indicated by way of example at location L3, a plurality of spatially separated measurements are required in the vicinity of location L3.

For each of the locations L1 to L5, the exact spatial positions are known and are available, for example, in the form of associated coordinates of a Cartesian coordinate system.

In order to record flow properties at some or all of these locations L1 to L5, a detection region, in particular a focus F, of a microscope M used, here symbolized in simplified fashion by the objective 47, can be directed to the respective location L1 to L5. For this purpose, the sample chamber 419 and/or the microscope M can be moved in a controlled manner (symbolized by the double-headed arrows) in at least one of the directions x, y and z, for example using the sample stage 49 (FIG. 3). The focus position F of the microscope M is advantageously settable in the direction z, for example by the microscope M being equipped with a zoom optical unit (not shown) and/or with a feature for adjusting the objective 47 in the direction z.

The control unit 413 is optionally equipped with a data memory or is suitably connected to such a memory for the transmission of data. Measurement values obtained can be stored in the data memory. Metadata such as the coordinates of the source of the measurement values and optionally information about properties of the medium used, the sample 48, the fluorophore used and also for example of temperatures, time durations, light regimes and similar can be assigned stored to the measurement values. In addition, properties of the sample chamber 419, for example its dimensions and/or properties of the wall 419.1, can be assigned to the measurement values and stored retrievably.

FIG. 8 is used to illustrate a possible configuration of the method according to the invention. Initially, at least one pair of detector elements 1 to 32 whose measurement values are intended to be used in the following steps is selected and defined. Similar applies to groups of pairs or to extended pairs (see above). Detection radiation which is coming from the sample chamber 419 from a previously selected and approached location L1 to L5 is detected and the resultant measurement values from the selected pairs are read in order to be able to supply them to the calculation of the corresponding cross correlations, in each case in the forward direction and back direction. The results of the cross correlations are then analyzed, flow properties are determined, and at least one flow profile is created.

It is optionally possible following the calculation of the cross correlations or in response to the results of the analysis to acquire further data and/or to reselect locations L1 to L5 and the corresponding pairs of detector elements 1 to 32.

The practical implementation of the method according to the invention can be assisted by means of menu navigation (“wizard”), which in each case proposes appropriate options for the individual method steps to a user.

The use of the menu navigation means that some technical requirements are specified by the user. For example, the latter specifies objectives to be used, supported laser lines and the correct beam path (illumination and/or detection). In addition or as an alternative, dyes or fluorophores to be used can be specified by the user. Suitable laser lines, beam paths and/or control parameters are accordingly proposed or set by means of the menu navigation. Moreover, a correct alignment of the detector 414 to be used is necessary in order to subsequently obtain good quality measurement values and in order to hence create the possibility of calculating a plurality of cross correlations.

A reference image of the sample can be recorded in a further step. For example, images of the sample at different wavelengths (“tracks”) can be recorded at one or more locations and can be displayed. A user and/or suitable programming (for example, image evaluation methods, use of artificial intelligence) can select at least one region of interest (ROI) on the basis of the displayed data. An advantage of using a plurality of wavelengths lies in a higher information density for the selection of the regions of interest to be carried out. An FCS measurement of the selected locations is subsequently carried out. This is implemented using only one wavelength.

The user can use the reference image as a map, on which they can define for example up to ten positions of in each case one spot (step 3). A corresponding symbol (for example: “spot selection icon”) reproduces the linked relationships between the selected spot positions and the image coordinates of the associated detector elements, in particular of the inner rings with the detector elements 1 to 19. The quantity and/or quality of the acquired measurement values, optionally per spot, can be displayed graphically, for example by virtue of count data being displayed with different color codes. This allows the user to select the positions differently when necessary, optionally by resorting to the second track (see above). To optimize the CMP (counts per molecule), it is possible to update the intensity of a laser used to excite the detection radiation, a gain (e.g., high voltage of the PMT) and the observed z-position.

A fourth step of the menu navigation is only available if a reference image is present. Measurement values are stored in a metafile in each step. All values can be retrieved if the menu navigation is started another time.

### REFERENCE SIGNS

1 to 32 Detector elements
41 Light source
42 Illumination beam path, excitation beam path
43 Main color splitter
44 Beam-shaping optical unit
Mirror
46 Scanner
47 Objective
48 Sample
49 Sample stage
410 Detection beam path
411 Zoom optical unit
412 Zoom drive
413 Control unit
414 Detector
415 Drive
416 Drive
4210 Common beam path
417 Container
418 Pump
419 Sample chamber
419.1 Wall (of sample chamber 419)
420 Window
F Focus position
L1 to L5 Location 1 to location 5
M Microscope

1. A method for determining flow properties in a sample chamber through which a medium flows, the method comprising:
A. detecting detection radiation from a confocal volume generated in a sample chamber with a plurality of detector elements of a detector in the form of a detector array at a plurality of points in time over a measurement period, wherein the detector is arranged in a plane conjugate to a rear-side image plane of an objective and measurement values from the detector elements can be analyzed individually; and
selecting at least one pair of detector elements, each partner of a pair being formed by at least one detector element;
B. creating cross correlations of the measurement values from the detector elements of at least one pair among themselves, wherein
B1. cross correlations are calculated starting from a first selected detector element in a first direction to a further selected detector element; and
B2. cross correlations are additionally calculated starting from the further selected detector element in a second direction (back direction) to the first selected detector element; and
C. analyzing the cross correlations in respect of the occurrence of a change in intensity of the measurement values from the selected detector elements,
wherein
the confocal volume is generated at at least two mutually different locations of the sample chamber, and
at each of the locations, a speed and optionally a movement direction are determined as flow properties of the medium on the basis of the cross correlations by virtue of a plurality of cross correlations being calculated over pairs with different alignments and all curves thus obtained being fitted with the directions and/or a speed as parameter, and
the speeds and, where appropriate, movement directions per location are assigned to each other and stored retrievably in order to create a speed profile over at least one region of the sample chamber.

2. The method according to claim 1, wherein a plurality of detector elements are combined to form a respective one of the partners of an extended pair.

3. The method according to claim 1, wherein a group of a plurality of pairs or plurality of extended pairs of detector elements is defined, wherein imaginary connecting lines of center points of the pairs or extended pairs run parallel to one another.

4. The method according to claim 3, wherein an average value of the cross correlations of a first direction and/or a second direction created from the measurement values from the pairs or extended pairs is formed or are formed.

5. The method according to claim 3, wherein a plurality of groups of detector elements is determined, wherein respective imaginary connecting lines between the groups are aligned differently from one another.

6. The method according to claim 3, wherein cross correlations of measurement values from the pairs or extended pairs of at least two different groups are formed.

7. The method according to claim 2, wherein the partners of a pair are spatially separated in each case by at least one detector element not belonging to the pair in question.

8. The method according to claim 1, wherein a point spread function of illumination radiation which is used for generating the confocal volume and is directed along an illumination beam path into the sample chamber and/or of the detected detection radiation is stretched in a direction transverse to a respective beam path so that it has an oval cross section.

9. The method according to claim 1, wherein the sample chamber is bounded in at least one direction x, y and z by a wall and, starting from the wall at least over a portion of a cross section of the sample chamber, a plurality of locations is selected and a confocal volume is generated there in each case.

10. The method according to claim 9, further comprising:
determining the influence of the wall of the sample chamber on at least one speed profile by setting properties of the wall in a relationship with determined flow properties.

11. The method according to claim 9, wherein the sample chambers are biological structures, and wherein the influence of the wall of the sample chamber modified with an implant on at least one speed profile is determined by setting properties of the modified wall in a relationship with determined flow properties.

12. The method according to claim 1, wherein the measurement values are input data for models and/or for verifying existing simulations.

13. A microscope for determining flow properties in a sample chamber through which a medium flows, comprising:
an objective for detecting detection radiation coming from a confocal volume generated in a sample chamber;
a detection beam path along which the detected detection radiation is steered to a detector in the form of a detector array having a plurality of detector elements, wherein the detector is arranged in a plane conjugate to the rear-side image plane of the objective, and measurement values from the detector elements can each be read individually;
an analysis and control unit configured for carrying out the method according to claim 1.
